(19) United States
(12) Patent Application Publication
(10) Pub. No.: US 2013/0305138 A1
(43) Pub. Date: Nov. 14, 2013

(54) SYSTEMS AND METHODS FOR ACQUIRING AND TRANSMITTING HIGH-RESOLUTION PATHOLOGY IMAGES

(71) Applicant: Diego German Gicovate, Modiin (IL)

(72) Inventor: Diego German Gicovate, Modiin (IL)

(73) Assignee: PACSTHOLOGY LTD., Kfar Monash (IL)

(21) Appl. No.: 13/893,942

(22) Filed: May 14, 2013

Related U.S. Application Data
(60) Provisional application No. 61/646,431, filed on May 14, 2012.

(51) Int. Cl. G06F 17/22

(52) U.S. Cl. CPC G06F 17/2247
USPC 715/234

(57) ABSTRACT

The disclosure relates to systems and methods for delivering digital pathology images and communication in medicine. Specifically, the disclosure relates to methods and systems for acquiring, processing, storing and delivering high resolution digital pathology images to remote users using communication networks.

### CROSS-REFERENCE TO RELATED APPLICATIONS

This application claims the benefit of priority to U.S. Provisional Application No. 61/646,431, filed May 14, 2012, the contents of which is incorporated herein by reference in its entirety.

### BACKGROUND

The present disclosure is directed to systems and methods for tele-pathology. Specifically, the disclosure is directed to methods and systems for acquiring, processing, storing and delivering high resolution digital pathology images to remote users using communication networks.

Over the past 20 years, the conversion from analog to digital formats has occurred in many, if not most, major data sets including music, video and communications. This transformation has included some, but not all medical specialties, for example, radiology. Conversion of additional medical specialty data such as histology and cytology to digital format is inevitable but requires storage and compression capabilities far greater than have heretofore been used.

Digital pathology today needs to address several problems that exist in pathology analysis and referencing. These problems are because; analysis is extremely data intensive, with many evaluations that require manual input than encounter several bottlenecks. In addition, there is increased probability of human error. Likewise, shortage of pathologists (as well as other technicians and assistances) is worsened by the demand from the existing pathologists to perform non-physicians tasks. All these factors lead to slow and tedious reporting environment, which is exacerbated by the increasing demand for sharing the accumulated information among large number of stake holders (e.g., hospitals, clinics, imaging centers, specialists, academicians and physicians for diagnostic purposes).

The DICOM standard specifies the handling, storing, printing, and transmitting of diagnostic data and images. Such standard includes a file format definition and a network communications protocol. The network communications protocol is an application protocol that uses the transmission control protocol-Internet protocol (TCP/IP) protocol to communicate between systems. DICOM files can be exchanged between two entities that are capable of receiving diagnostic data and images in DICOM format. The DICOM standard is also known as NEMA standard PS3 and ISO standard 12052. However, to make matters more complicated, there is no single, complete DICOM standard, the number of image acquisition tools is varied, and the number of vendors offering different solutions is quite large.

In addition, Pathologists require slide scanned images to remotely evaluate and diagnose necessary information. Towards this end Digital Pathology (DP) must produce high quality, color images. These images, which typically have a size of several gigabytes, require suitable software to enable electronic transmission without data loss, which, in turn require expensive broadband network connections between end users—laboratories, hospitals, clinics and on-call pathologists. As a result DICOM biopsy images on conventional computers are virtually impossible to share electronically namely to distribute and display. Consequently, most of the biopsy consultations today involve transfer of the actual slides by regular or express mail services.

Accordingly, there is a need to develop solutions to assist the pathologist to improve work flow and existing portfolio management in order to improve decision processes and provide better patient care. Furthermore, other advantageous features and characteristics of the present disclosure will become apparent from the subsequent detailed description and claims, taken in conjunction with the accompanying figures and the foregoing technical field and background.

### SUMMARY

Disclosed, in various embodiments, are systems and methods for acquiring, processing, storing and delivering high-resolution digital pathology images to remote users using communication networks.

In an embodiment, provided herein is a network-enabled, computer-implemented method of delivering a portion of a high resolution digital pathological image to a remote user over a communication network comprising: accessing a library of high resolution digital pathology images by the remote user, wherein the library resides on a primary server; selecting a high-resolution digital pathology image; using a web server, defining x,y, coordinates in the high-resolution digital pathology image, wherein the x,y, coordinates define a region of interest (ROI); rendering the region of interest onto a HTML-5 image; and delivering the HTML-5 image copy to the remote user via a web server.

In another embodiment, provided herein is a non-transitory computer-readable storage medium, storing computer code for: accessing a library of high-resolution digital pathology images. wherein the library resides on a primary server; selecting a high-resolution digital pathology image; using a web server, defining x,y, coordinates in the high-resolution digital pathology image, wherein the x,y, coordinates define a region of interest (ROI); rendering the region of interest onto a HTML-5 image; and delivering the HTML-5 image copy to the remote user via a web server, wherein the non-transitory computer-readable storage medium resides on a primary server.

In yet another embodiment, provided herein is a network enabled, computer-based system for transmission and display of at least a portion of a high-resolution digital pathology image on a remote display, the system comprising: a primary server; an acquisition module, in communication with the primary server; a report generating module, in communication with the primary server; and a remote user system, in communication with the primary server, wherein the primary server is configured to convert a predetermined portion of the high resolution pathology image to a HTML5 image, wherein the predetermined portion of the image is based on display coordinates defined by the remote user.

These and other features of the systems and methods for comparing and editing plurality of structured data files will become apparent from the following detailed description when read in conjunction with the drawings, which are exemplary, not limiting.

### BRIEF DESCRIPTION OF THE FIGURES

The figures along with the detailed description are incorporated and form part of the specification and serve to further illustrate examples, embodiments, and the like, and explain various principles and advantages, in accordance with this disclosure, wherein:

FIG. 1 is a schematic illustrating an embodiment of the primary server software connections;

FIG. 2, is a schematic illustrating an embodiment of the end user's interaction with the primary server software mediated by a web server;

FIG. 3, is a schematic illustrating an embodiment of the components of the primary server software;

FIG. 4, is a schematic illustrating an embodiment of the full DICOM pathology image and the segmented X,Y, image extracted from it;

FIG. 5, is a schematic illustrating an embodiment of the sample's frame selection; and

FIG. 6, is a schematic illustrating an embodiment of the system overview of the inputs and outputs of the server sampling function.

### DETAILED DESCRIPTION OF PREFERRED EMBODIMENTS

Provided herein are embodiments of systems and methods for acquiring, processing, storing and delivering high-resolution digital pathology images to remote users using communication networks. These have utility in the telemedicine and pathology.

The picture archiving and communications system (PACS) provided herein encompasses a suite of software and applications that enable the user the integration of various imaging equipment, including scanners, servers, workstations, printers and network equipment, from multiple manufacturers into a PACS. Sharing of the data among, for example, hospitals, clinics, imaging centers, physicians, and specialists can be location neutral, inside, outside or between hospitals and clinics. Sharing can be unique (e.g., encrypted), secure and HIPAA compliant.

In addition, the systems and methods described herein for acquiring, processing, storing and delivering high resolution digital pathology images to remote users using communication networks can provide seamlessly integrated interfaces to image acquisition systems like slide scanners, digital cameras, image repositories, etc. Likewise, the system can be configured to facilitate communication with others systems in the hospital such a LIS (Laboratory Information System), HIS (Hospital Information System) and PACS (Picture Archival Communication System). Moreover, the system can be configured to support HL7 message syntax and DICOM interfaces in order to synchronize patient demographics and demographic updates, biopsy orders, export results and reports.

A DICOM file, as used in the methods and systems for acquiring, processing, storing and delivering high resolution digital pathology images to remote users using communication networks described herein, which can also be generally referred to as a diagnostic patient study, a diagnostic image, or a high-resolution digital pathology image, can include a header and one or more diagnostic images. The header, which can also be referred to as diagnostic data, can include patient data and exam data. Further, extracting the header from a DICOM file can leave one or more diagnostic images. The patient data can include, for example, patient demographics such as the patient's name, identification, age, sex, birth date, size, weight, ethnicity, comments (for example, voice recorded comments), and contact information. The exam data can include, for example, a medical record locator, study date, study time, study description, station name, accession number, study identifier, study comments, referring physician name, physician of record, performing physician name, scheduled performing physician name, operator name, admitting diagnoses description, manufacturer model name, derivation description, modality, institution name, institution address or data including at least one of the foregoing. Also, a DICOM file can be stored on a PACS and can be distributed using, for instance, the Internet, a compact disc (CD), a digital versatile disk (DVD), a flash drive, a magnetic drive or another non-transitory computer-readable medium.

To ensure patient privacy, medical discretion and efficient data management the HIPAA standard of data management can be followed (Health Insurance Portability and Accountability Act). Towards this end a logs record and auditory system can be incorporated in the system described.

The system can also include a plurality of heterogeneous hardware and software components (e.g., wired/wireless communications hardware/software) configured to implement the methods described herein thus providing one or more services. An additional Web Exchange module can include, for example, a service provider configured to provide access to the one or more services provided by the Web Exchange module via a network to one or more service requesters configured to access the one or more services via the service provider over the network. The Web Exchange system can be configured and implemented according to a vendor-independent Web Service architecture generated according to a structured design process for designing and generating vendor-independent Web Service architectures such that, for example, the plurality of heterogeneous hardware components are organized according to two or more tiers and two or more layers of the Web Exchange architecture, and/or one or more Web Exchanges design patterns are applied to the Web Exchange architecture, such that each design pattern models a particular structure that is applicable to the Web Exchange. For example, one Web Exchange design pattern/architecture may be associated with acquiring a high-resolution digital pathology image from an end user, while a second Web Exchange design pattern/architecture may be associated with providing the image to the remote end-user. In an embodiment, the system can be configured to operate in 3 architecture layers: for example, core software, a communication layer with a web server and a presentation layer. Accordingly, the web-browser-based architecture can be configured to deliver full PACS workstation to any networked devices with web browsers, for example, PC, Mac, Linux/Unix, Tablet, PDA, smart phones, or other similarly capable Touring machines.

Accordingly and in an embodiment, provided herein is a network-enabled, computer-implemented method of delivering a portion of a high resolution digital pathological image to a remote user over a communication network including: accessing a library of high resolution digital pathology images by the remote user, wherein the library resides on a primary server; selecting a high-resolution digital pathology image; using a web server, defining x,y, coordinates in the high-resolution digital pathology image, wherein the x,y, coordinates define a region of interest (ROI); rendering the region of interest onto a HTML-5 image; and delivering the HTML-5 image copy to the remote user (e.g., “client” or “end-user”) via a web server. In an embodiment, the ROI is smaller than the whole image.

Viewer technology can be based on DICOM-to-html5 and/or JPG-to-flash technology. Accordingly, the system can be configured to enable the creation of continuous flash presentations of exceptionally large pathology slide image scans (equal to or greater than 1 GB). The primary server can be responsible for generating (in other words, rendering) a set of Internet-standard-format images of different resolutions/sizes. The generated images can be ready to display in any modern web browser and can be, for example, GIF, JPEG, PNG, lossy and lossless. The rendering operation can occur when the image datasets first arrive into the system through the acquisition module, or when remote user clients request them. When the images are served (in other words, delivered) to the clients, the servers pick the best matching resolution/size with the client display screen and send the chosen images to clients. The (remote-user's) pre-defined (in other words, the coordinates for the region of interest (ROI)) rendered image sizes can be configured to include original image size—w pixel by h pixel, and a set of smaller sizes that match different type of devices' displays: for example, 2048×2560 pixels, 1680×1050 pixels, 1024×768 pixels, 960×640 pixels, 854×480 pixels, 480×320 pixels with the maximum size generated being the size of the original DICOM image. See e.g., FIGS. 2, and 4.

In typical fixed-site applications, the image data may be transferred over a relatively high-bandwidth network to client computer systems that in turn, may render the image. Client systems may typically implement a local image navigation system to provide zoom and or pan functions based on user interaction (in other words, client GUI is used to define the x,y, coordinates). However, in such systems full resolution image presentation may be subject to the inherent transfer latency of the network, which can be exacerbated by the large size of the data file. Accordingly, in an embodiment, the step of rendering the image used in the methods described herein, can be preceded by a step of detecting and determining the available bandwidth for delivering the image; accordingly, determining the compression ratio for the image; and compressing the image. In other words, compression ratio of the rendered ROI will be a function of the available bandwidth.

To “render” is used herein to describe the act of transforming a signal of an image from one state to another such as, for example, receiving a signal of an image and reducing that signal to a viewable form such as a hardcopy print of the image (in other words, an HTML-5 image copy). The term “rendering” is intended to be broadly interpreted. In one respect, rendering means reducing a signal of the document image to a hardcopy print or displaying the image on a display device such as a monitor or LCD. In another, rendering means communicating the image to another device over a network for further processing, for example. Such communication may take the form of transmitting, wirelessly or via a wire or cable, the image signal over a network such as a LAN or Internet. In yet another, rendering means storing the image to a storage device.

In addition, the primary server can also accept and store images that are rendered by a client and sent by the client to the server for the purpose of reuse either by other clients or at a later time by the same client. The high-resolution pathology image is jpeg, jpeg2000, swf, bmp, DICOM, and may include additional study or report data in DICOM SR, pdf or doc formats.

Elements and modules that are described as being in communication with each other need not be in continuous communication with each other, unless expressly specified otherwise. In addition, elements and/or modules of the system that are in communication with each other may communicate directly or indirectly, periodically or aperiodically, synchronously or asynchronously. Further, elements and/or modules of the system described as being in communication with each other may communicate indirectly via one or more intermediaries. A description of an embodiment with components in communication with each other does not imply that all such components are required. Although process steps, method steps, algorithms, or the like may be described in a sequential order, such processes, methods, algorithms, or the like may be configured to operate in alternative orders. The steps of processes and methods described herein may be performed in any order practical. Further, some steps may be performed simultaneously or concurrently.

The database server and the library including the high-resolution digital pathology images may be distinct from one another or the database server and the library may be logically separated, but co-located in another embodiment.

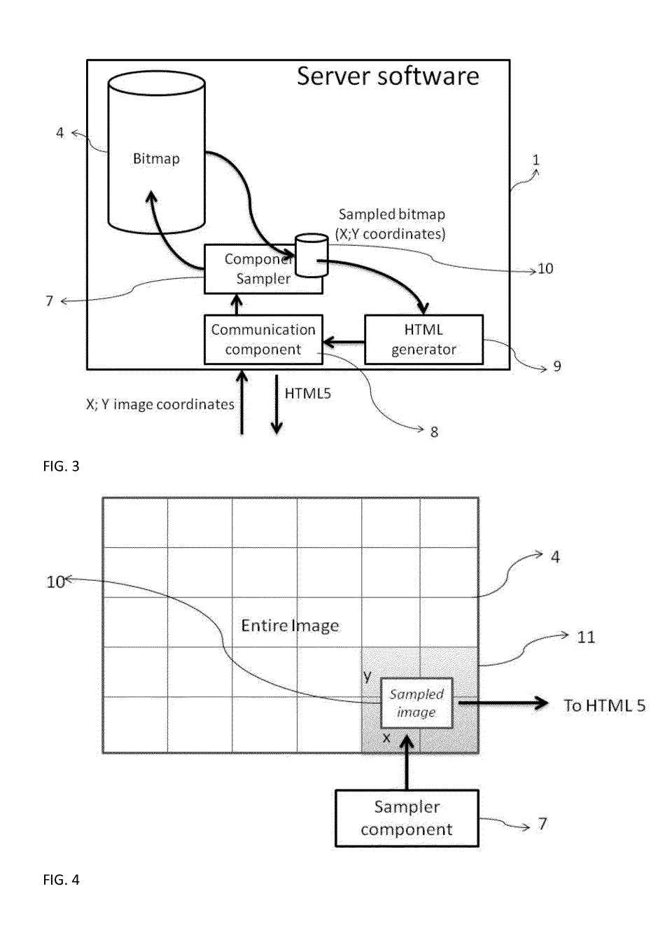

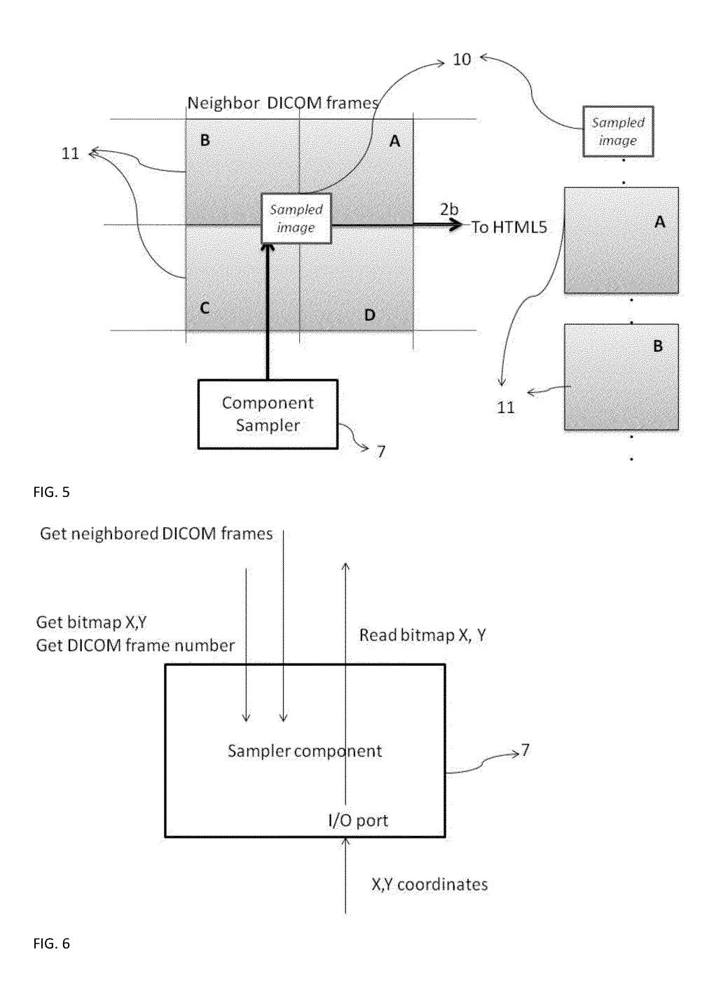

The primary server can include several sub-components. These sub components can be, for example;
i) The Database and data link software
ii) The Communication software subsystem
iii) The Webserver and interface subsystem
iv) The Main software server
v) The Viewer
vi) The Streaming subsystem with a Flash, HTML5 or JPEG region of interest (ROI) on demand streaming system (see e.g., FIG. 3)

Further, the primary server is configured to store and/or display the high-resolution pathology image, report and/or transmit the image, and communicate with the remote user system. The code or logic implementing the various aspects described herein may be implemented in a “transmission signal,” where the transmission signal may propagate through space or through a transmission media, such as an optical fiber and a copper wire. The transmission signal in which the code or logic is encoded may further include a wireless signal, a satellite transmission, a radio wave, an infrared signal, a Bluetooth signal, and a Wi-Fi. The transmission signal in which the code or logic is encoded is capable of being transmitted by a transmitting station or device and received by a receiving station or device, where the code or logic encoded in the transmission signal may be decoded and stored in hardware or a non-transitory computer-readable medium at the receiving and transmitting stations or devices.

In an embodiment, the primary server used in the methods and systems for acquiring, processing, storing and delivering high resolution digital pathology images to remote users using communication networks described herein, can including: a library module of high-resolution pathology images, the library stored on a non-transitory computer-readable medium; a communication module; a user interface; a display module; a streaming module; and a computer-readable storage medium, storing computer code for implementing the configuration of the primary server. The terms “streaming media” are herein intended to mean media signals that including information intended to be communicated to and used by a destination device in a temporal, streaming fashion. The term “streaming” as applied to streaming predetermined portions of the high resolution digital pathology images refers to signals communicated and processed in a continuous manner over time, or signals that may be communicated in a series of discrete packets, pieces, or blocks that are interrelated and may be thereafter used by the destination device in a continuous, interrelated fashion. Examples of streaming media signals for the purpose of this disclosure can therefore be video, audio, audio combined with video, and data strings such as temporal telemetry. The terms “streaming media” are most typically used by reference to digitized forms of data representing the subject media (in other words, the images disclosed herein).

Also, the term “non-transitory computer-readable medium” may include a single medium or multiple media (e.g., a centralized or distributed database, or associated caches and servers) that store the one or more instructions or images. The term “non-transitory computer-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures used by or associated with such instructions (e.g., the high resolution digital pathology images described herein). The term “non-transitory computer-readable medium” shall accordingly be taken to include, but not be limited to, solid-state memories, and optical and magnetic media. Specific examples of non-transitory machine-readable media include non-volatile memory, including by way of exemplary semiconductor memory devices (e.g., EPROM, EEPROM, and flash memory devices); magnetic disks such as internal hard disks and removable disks; magneto-optical disks; and CD-ROM and DVD-ROM disks. The term “disk” as used herein refers to a storage disk or other memory that can store data for a computer system.

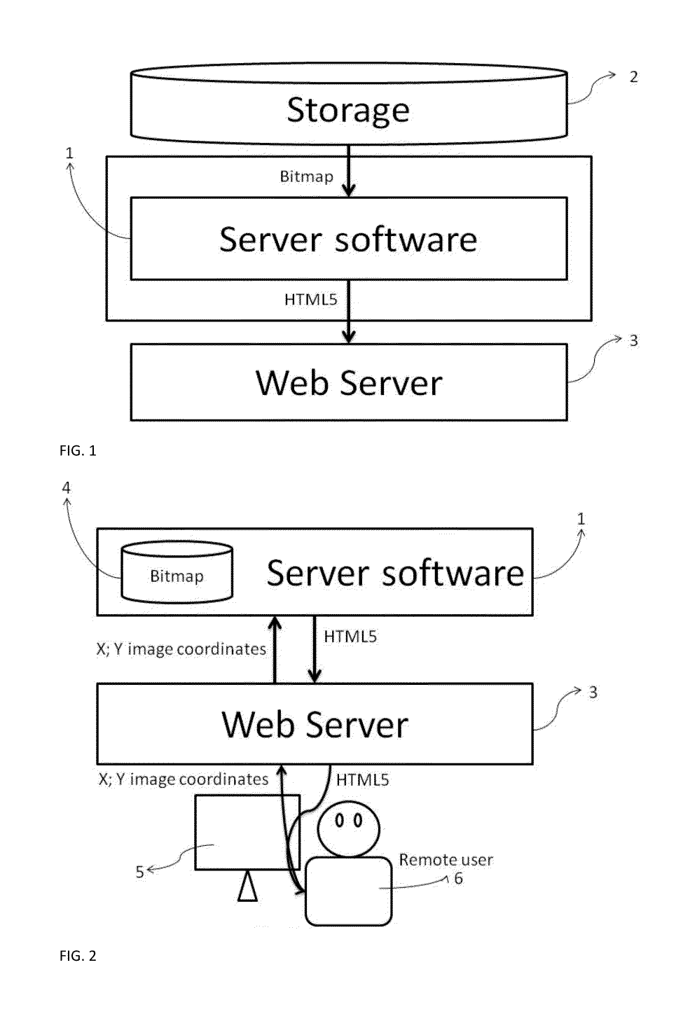

The server software package described in FIG. 1 can be configured to perform various functions. As shown in FIG. 1 the server software can be configured to obtain a bitmap from the storage facilities delivered as a HTML5 image to the generic web server, serving the client. The web server can routinely refresh the page now containing the HTML5 images sampled and produced from the original DICOM pathology image, stored in the library.

In an embodiment, the interface component of the primary server that can be accessed when scanning the high-resolution digital pathology image using the acquisition module, can be configured to connect to and retrieve requested data from a back-end content management server (or, in other words, the primary server).

The acquisition module can be installed in a scanning server connected to the system's scanner or a video microscope. See e.g., FIG. 2. In an embodiment, the acquisition module or server, can be configured to get data from the primary server through a secure/encrypted Internet or LAN connection. For example, an image reconstructor (i.e., “image processor”) receives sampled and digitized x-ray data from a scanner and performs high speed reconstruction. The reconstructed image is applied as an input to the primary server which stores the image in a mass storage device. The software can also be configured to reconcile and compress the images internally and deliver these images to the primary server for storage. This component can also be able to convert and notice folder images and deliver only the appropriate images to the primary server.

As illustrated in FIG. 2, a pathologist end user (point 6) can define in his computer monitor (point 5) the selected image's coordinates, whereby the coordinates can be transferred to the web server (point 3) via the server software (point 1). The software can then register the high definition DICOM pathology images (point 4) while recording the smaller area to be converted (e.g., rendered) to HTML5 and be displayed by the web server (point 3) on the end user pathologist's screen. In an embodiment, the step of rendering further includings a step of rendering an additional region of a size equivalent to the x,y, coordinates defining the region of interest, wherein the additional region is adjacent to the side of the region of interest. As illustrated in FIG. 4, whereby DICOM image frames are represented by empty rectangles that together compose the full pathology image (point 4). A sampled x,y area (point 10) can be extracted by the sampler (point 7). The coordinates can then be relayed to the HTML5 generator as defined in FIG. 3. The sampler (point 7) verifies the DICOM frame numbers that contain part or all the x, y, area selected by the end user. These frames, clockwise, will be transformed to HTML5 and published on the HTML5 page as a continuation of the displayed bitmap. As a result the end user will not need to wait to get adjacent image fields of the displayed bitmap (AOI). The process can be observed in FIG. 5 where adjacent frames (point 11) are transmitted after the sample bitmap. Accordingly, in an embodiment, the step of rendering an additional region of a size equivalent to the x,y, coordinates defining the region of interest, includings defining up to eight additional regions.

In an embodiment, the term “module” refers to any currently known or later developed hardware, software, firmware, artificial intelligence, fuzzy logic, or combination of hardware and software that is capable of performing the functionality associated with that element. In another embodiment, the term module should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components including a general-purpose processor configured using software, the general-purpose processor may be configured as respective different modules at different times. Software may accordingly configure the processor to constitute a particular module at one instance of time and to constitute a different module at a different instance of time.

In an embodiment, the acquisition module used in the methods and systems for acquiring, processing, storing and delivering high resolution digital pathology images to remote users using communication networks described herein, can be configured to acquire and deliver newly scanned high-resolution pathology image to the primary server (see e.g., FIG. 3). Once the image file is generated, the file may be transmitted over the facility's network to, for example, the physician's viewing station either within the facility or at a remote location. Moreover, the file can be read immediately or it can be queued for later reading. In addition, the report can be archived in the same way as images produced by other modalities (e.g., CT scanner) and can be made available subsequently via query/retrieve for patient follow-up. For example, each time a patient returns for a follow-up scan, prior analysis reports are immediately available on-line for comparison.

In an embodiment, the image processing module can be configured to enable analysis, measurements, cell counts and morphometry tools. These tools can be configured to help the pathologist to identify pathological tissue on biopsy samples and work faster. Some of the add-on modules can further include state of the art pattern and cell recognition algorithms, Cell/nucleus counting; Tumor kinetics analysis; ELISA staining intensity analysis; and others. Other actions configured into the image processing module can be raw pixel data preprocessing, Crop, Window/Level adjustment, Invert, Zoom, Rotate, Filter, Noise Adding/Reduction, Edge Detection, Fusion and others. In an embodiment, all of these actions can happen inside the image processing module locally, without communicating with servers. In an embodiment, the image processing module used in the methods and systems for acquiring, processing, storing and delivering high resolution digital pathology images to remote users using communication networks described herein, can be configured to append analysis and image post-process alterations to an existing high-resolution pathology image stored in the primary server.

In an embodiment, converting the high resolution digital pathology image used in the methods and systems for acquiring, processing, storing and delivering high resolution digital pathology images to remote users using communication networks described herein, can provide the functionalities of a traditional PACS workstation at the native level with zero plugin or software installation. This is achieved by using an application programming interface (API) to directly update bitmap in HTML5 canvas element. For example, as illustrated in FIG. 3 showing a detail of the high definition DICOM pathology image sampling process whereby coordinates entered and received by the web server are transmitted to the server software (point 1) which via the communication function (point 8) forwards them to the sampler (point 7). The sampler deciphers the high definition DICOM pathology image (point 4), extracts the sampled bitmap (point 10) which is then transferred to the HTML 5 generator (point 9) that generates the HTML 5 image. This image is copied and synchronized by the communication component that will copy it to the web server.

In an embodiment, the system further includes a report-generating module. The report-generating module can be configured to be modular. For example, the module can include user customizable text reports with options for pathology reports, image embedded screen captured images with printing options for paper PDF and/or email output. These capabilities can support DICOM SR reports. In addition a template and auto template generation options can be configured in order to speed up reporting and reduce human error and provide voice recognition and recording tools. Accordingly and in an embodiment, the report-generating module can be configured to provide voice and/or written annotations to an existing high-resolution pathology image stored in the primary server, and deliver the annotated image to the remote user. For example, the systems can allow the technologist to define the position of a patient relative to the imaging receptor, using a remote (end-) user interface. The system can then automatically place “digital” laterality markers on the appropriate side of the image. Other annotations can also be made to indicate patient positioning (e.g., “upright”, “supine”, etc.).

An end-user interface component, with the end-user and/or user-specific data having an internal content representation that correlates to an external appearance in a plurality of content option. The end-user interface and/or user-specific data server can incorporate the requested image data (e.g., Pathology DICOM) retrieved from the back-end content management system (in other words the primary server) into a current view in the end-users' display means. The user-specific data server can be coupled to the end-user dedicated interface and likewise, a user-specific data server can be coupled to another end-user dedicated interface. The end-user interface can be configured to retrieve requested data incorporated into the user-specific data server and to display the requested data retrieved as one or more content items.

The software, information and/or data may further be transmitted or received over a global communications network using a transmission medium via a network interface device utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., LTE, WiFi and WiMax networks). The term “transmission medium” shall be taken to include any intangible medium that is capable of storing, encoding, or carrying instructions for execution by the machine (e.g., a computer), and includes digital or analog communications signals or other intangible medium to facilitate communication of such software. In an embodiment, the methods described herein make use of the systems and non-transitory, computer-readable medium provided herein.

An operational Turing type apparatus (e.g., a Turing machine) can be provided to the client (or remote end-user, e.g., a physician) and be configured and/or adapted to connect to the network. That apparatus, which can be, for example, a mobile phone, a smart phone, a touch phone, a personal digital assistant (PDA) phone, or an ultra-mobile personal computer (UMPC) or a Personal computer (PC) a Smart TV a cable Box or another Turing type apparatus configured to run the dedicated software, may be configured to display the images provided herein.

In an embodiment, the systems described herein are used with the methods described herein. Accordingly, provided herein is a computer implemented method of delivering a high-resolution pathology image to a user remote from the storage location of the pathology image, implementable in a system including a primary server, an acquisition module in communication with the primary server, an image processing module in communication with the primary server, a report generating module in communication with the primary server and remote user system in communication with the primary server, the method including the steps of: using the acquisition module, obtaining a high-resolution pathology image; storing the high-resolution pathology image on the primary server; upon demand, converting a predetermined portion of the image to a HTML 5 image, wherein the predetermined portion of the image is based on the display coordinates defined by the remote user; and using the primary server, transmitting HTML 5 copy of the predetermined high-resolution portion of the pathology image to the remote user.

Accordingly, provided herein is a network-enabled, computer-implemented method of delivering a portion of a high resolution digital pathological image to a remote user over a communication network including: accessing a library of high resolution digital pathology images by the remote user, wherein the library resides on a primary server; selecting a high-resolution digital pathology image; using a web server, defining x,y, coordinates in the high-resolution digital pathology image, wherein the x,y, coordinates define a region of interest (ROI); rendering the region of interest onto a HTML-5 image; and delivering the HTML-5 image copy to the remote user via a web server, wherein (i) the step of rendering further includes a step of rendering an additional region of a size equivalent to the x,y, coordinates defining the region of interest, wherein the additional region is adjacent to the side of the region of interest, (ii) the step of rendering an additional region of a size equivalent to the x,y, coordinates defining the region of interest, includings defining up to eight additional regions, wherein (iii) the step of rendering is preceded by a step of detecting and determining the available bandwidth for delivering the image; accordingly, determining the compression ratio for the image; and compressing the image, (iv) further including determining the screen resolution of the remote user, wherein (v) the step of defining x,y, coordinates in the high-resolution digital pathology image is carried out using a graphic user interface, wherein (vi) the step of accessing the library of high-resolution digital pathology images is preceded by: obtaining a high-resolution digital pathology image; converting the obtained image to a bitmap; and storing the bitmap of the image in the library, (vii) further including annotating the HTML 5 image copy with voice and/or text analysis, wherein (viii) the additional region rendered resides in a random access memory (RAM), wherein (ix) the high-resolution pathology image is jpeg, jpeg2000, swf, bmp, DICOM, DICOM SR, pdf, or doc image, and (x) the image has a size equal to or greater than 1 GB.

In another embodiment, provided herein is a non-transitory computer-readable storage medium, storing computer code for: accessing a library of high resolution digital pathology images. wherein the library resides on a primary server; selecting a high-resolution digital pathology image; using a web server, defining x,y, coordinates in the high-resolution digital pathology image, wherein the x,y, coordinates define a region of interest (ROI); rendering the region of interest onto a HTML-5 image; and delivering the HTML-5 image copy to the remote user via a web server, wherein the non-transitory computer-readable storage medium resides on a primary server, (xi) further including instructions for rendering an additional region of a size equivalent to the x,y, coordinates defining the region of interest, wherein the additional region is adjacent to the side of the region of interest, (xii) further including instructions for defining up to eight additional regions, (xii) further including instructions for detecting and determining the available bandwidth for delivering the image; accordingly, determining the compression ratio for the image; and compressing the image for delivery, (xiii) further including instructions for determining the screen resolution of the remote user.

In another embodiment, provided herein is a network enabled, computer-based system for transmission and display of at least a portion of a high-resolution digital pathology image on a remote display, the system including: a primary server; an acquisition module, in communication with the primary server; an image processing module, in communication with the primary server; a report generating module, in communication with the primary server; and a remote user system, in communication with the primary server, wherein the primary server is configured to convert a predetermined portion of the high resolution pathology image to a HTML5 image, wherein the predetermined portion of the image is based on display coordinates defined by the remote user, wherein (xiv) the report generating module is configured to provide voice and/or written annotations to an existing high-resolution pathology image stored in the primary server, and delivers the annotated image to the remote user, and (xv) the primary server includes: a library module of high-resolution pathology images, the library stored on a non-transitory computer-readable medium; a communication module; a user interface; a display module; a streaming module; and a computer-readable storage medium, storing computer code for implementing the configuration of the primary server.

The terms “first,” “second,” and the like, herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the user(s) includes one or more user). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The term “plurality”, as used herein, is defined as two or as more than two. The term “another”, as used herein, is defined as at least a second or more. The terms “including” and/or “having”, as used herein, are defined as including (i.e., open language).

The term “communication” and its derivatives (e.g., “in communication”) may refer to a shared bus configured to allow communication between two or more devices, or to a point to point communication link configured to allow communication between only two (device) points.

The terms “determine”, “calculate”, and “compute,” and variations thereof (e.g., detect), as and if used herein, are used interchangeably and can include any type of methodology, process, mathematical operation, or technique.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

1. A network-enabled, computer-implemented method of delivering a portion of a high resolution digital pathological image to a remote user over a communication network comprising:
(a) accessing a library of high resolution digital pathology images by the remote user, wherein the library resides on a primary server;
(b) selecting a high-resolution digital pathology image;
(c) using a web server, defining x,y, coordinates in the high-resolution digital pathology image, wherein the x,y, coordinates define a region of interest (ROI);
(d) rendering the region of interest onto a HTML-5 image; and
(e) delivering the HTML-5 image copy to the remote user via a web server.

2. The method of claim 1, wherein the step of rendering further comprises rendering an additional region of a size equivalent to the x,y, coordinates defining the region of interest, wherein the additional region is adjacent to the side of the region of interest.

3. The method of claim 2, wherein the rendering an additional region of a size equivalent to the x,y, coordinates defining the region of interest, comprises defining up to eight additional regions.

4. The method of claim 1, wherein the rendering is preceded by:
(a) detecting and determining the available bandwidth for delivering the image;
(b) accordingly, determining the compression ratio for the image; and
(c) compressing the image.

5. The method of claim 4, further comprising determining the screen resolution of the remote user.

6. The method of claim 1, wherein the defining x,y, coordinates in the high-resolution digital pathology image is carried out using a graphic user interface.

7. The method of claim 1, wherein the accessing of the library of high-resolution digital pathology images is preceded by:
(a) obtaining a high-resolution digital pathology image; converting the obtained image to a bitmap; and
(b) storing the bitmap of the image in the library.

8. The method of any one of claim 1, further comprising annotating the HTML 5 image copy with voice and/or text analysis.

9. The method of claim 2, wherein the additional region rendered resides in a random access memory (RAM).

10. The method of claim 1, wherein the high-resolution pathology image is jpeg, jpeg2000, swf, bmp, DICOM, DICOM SR, pdf, or doc image.

11. The method of claim 10, wherein the image is a DICOM image.

12. The method of claim 1, wherein the high-resolution digital pathology image has a size equal to or greater than 1 GB.

13. A non-transitory computer-readable storage medium, storing computer code for:
(a) accessing a library of high resolution digital pathology images. wherein the library resides on a primary server;
(b) selecting a high-resolution digital pathology image;
(c) using a web server, defining x,y, coordinates in the high-resolution digital pathology image, wherein the x,y, coordinates define a region of interest (ROI);
(d) rendering the region of interest onto a HTML-5 image; and
(e) delivering the HTML-5 image copy to the remote user via a web server, wherein the non-transitory computer-readable storage medium resides on a primary server.

14. The non-transitory computer-readable storage medium of claim 1, further comprising instructions for rendering an additional region of a size equivalent to the x,y, coordinates defining the region of interest, wherein the additional region is adjacent to the side of the region of interest.

15. The non-transitory computer-readable storage medium of claim 14, further comprising instructions for defining up to eight additional regions.

16. The non-transitory computer-readable storage medium of claim 13, further comprising instructions for:
(a) detecting and determining the available bandwidth for delivering the image;
(b) accordingly, determining the compression ratio for the image; and
(c) compressing the image for delivery.

17. The non-transitory computer-readable storage medium of claim 16, further comprising instructions for determining the screen resolution of the remote user.

18. A network enabled, computer-based system for transmission and display of at least a portion of a high-resolution digital pathology image on a remote display, the system comprising:
(a) a primary server; an acquisition module, in communication with the primary server;
(b) a report generating module, in communication with the primary server; and
(c) a remote user system, in communication with the primary server, wherein the primary server is configured to convert a predetermined portion of the high resolution pathology image to a HTML5 image, wherein the predetermined portion of the image is based on display coordinates defined by the remote user.

19. The system of claim 18, wherein the report generating module is configured to provide voice and/or written annotations to an existing high-resolution pathology image stored in the primary server, and delivers the annotated image to the remote user.

20. The system of claim 2, wherein the primary server comprises:
(a) a library module of high-resolution pathology images, the library stored on a non-transitory computer-readable medium;
(b) a communication module;
(c) a user interface;
(d) a display module;
(e) a streaming module; and
(f) a computer-readable storage medium, storing computer code for implementing the configuration of the primary server.
